(19) United States
(12) Patent Application Publication
(10) Pub. No.: US 2002/0056420 A1
(43) Pub. Date: May 16, 2002

(54) INTERNAL COMBUSTION ROTARY ENGINE

(76) Inventor: CHANCHAI SANTIYANONT, BANGKOK (TH)

Correspondence Address: LADAS & PARRY, 26 WEST 61ST STREET, NEW YORK, NY, 10023, US

(21) Appl. No.: 09/396,079

(22) Filed: Sep. 14, 1999

(30) Foreign Application Priority Data
Sep. 18, 1998 (TH) 046184

(51) Int. Cl. F02B 57/00

(52) U.S. Cl. 123/43 R; 123/44 R

(57) ABSTRACT

An internal combustion rotary engine of the type comprising a rotor, an output shaft as the rotor axis, crankshafts mounting on output shaft, pistons reciprocable in piston chambers within the rotor, piston rods connecting the pistons to the crank of crankshaft. This rotary engine is characterized by the ignition force perpendicular to the output shaft radius, by radially spaced the crankshaft axis from output shaft axis, by connection between the output shaft and the crankshafts to concurrently synchronize them.

### FIELD OF THE INVENTION

The present invention related generally to automotive engineering and, more specifically, to an internal combustion rotary engine of the type including reciprocating pistons which rotate around its axis of rotation.

### DESCRIPTION OF THE PRIOR ART

In conventional four-stroke internal combustion engine, ignition occurs when a piston is at top position (top dead center), so explosion force is passed through the center of crankshaft (output shaft), thus some power was lost into heat energy instead of being the output driving force. The main objective of this invention is to recover the loss of power and improve the efficiency of the engine.

During the year 1964-1965 this new four-stroke internal combustion engine had been invented, each piston chamber is perpendicular to the radius of output shaft. Piston is reciprocated by rotation of its crankshaft. Piston chamber is wrapped with cylindrical shape valve that has curved end to match inner cylindrical surface of casing in order to close and open gas inlet port and exhaust outlet port. Gas inlet port, exhaust outlet port and spark plug holding port are formed on outer cylinder.

Regarding to prior art, related patents are U.S. Pat. Nos. 4,421,073; 4,106,443; 4,370,109. The description therein illustrated the internal combustion rotary engine with a somewhat similar shape as the proposed engine but totally different principles and details as follows.

Regarding U.S. Pat. No 4,421,073, there is no crankshaft or it is not separated from drive shaft. The rotor axis is eccentric to drive shaft.

Regarding U.S. Pat. No. 4,106,443, two pistons are connected by common rod, and operated by common rod sliding, not by rotating crankshaft.

Regarding U.S. Pat. No. 4,370,109, The engine has a rotary piston, not reciprocating piston, and operated by piston rod, crankshaft, and drive train to rotate two sets of synchronous piston.

### SUMMARY OF THE INVENTION

An internal combustion rotary engine comprising: a casing defining a cylindrical chamber; a rotor with output shaft as an axis in the said cylindrical chamber; crankshaft with pinion gear at the rear end in the rotor; piston chamber and piston in the rotor exists; drive train provided to synchronize the rotation of the output shaft and the crankshaft.

### BRIEF DESCRIPTION OF THE DRAWINGS

The above and other objectives and advantages of the present invention will be understood with reference to the following detail description of embodiment thereof which is illustrated, by way of example, in the accompanying graphics; in which:

FIG. 1 is diagram illustrating suction-port, exhaust-port and spark plug position for the first set of piston;

FIG. 2 is diagram illustrating suction-port, exhaust-port and spark plug position for the second set of piston;

FIG. 3 is perspective view of the engine components;

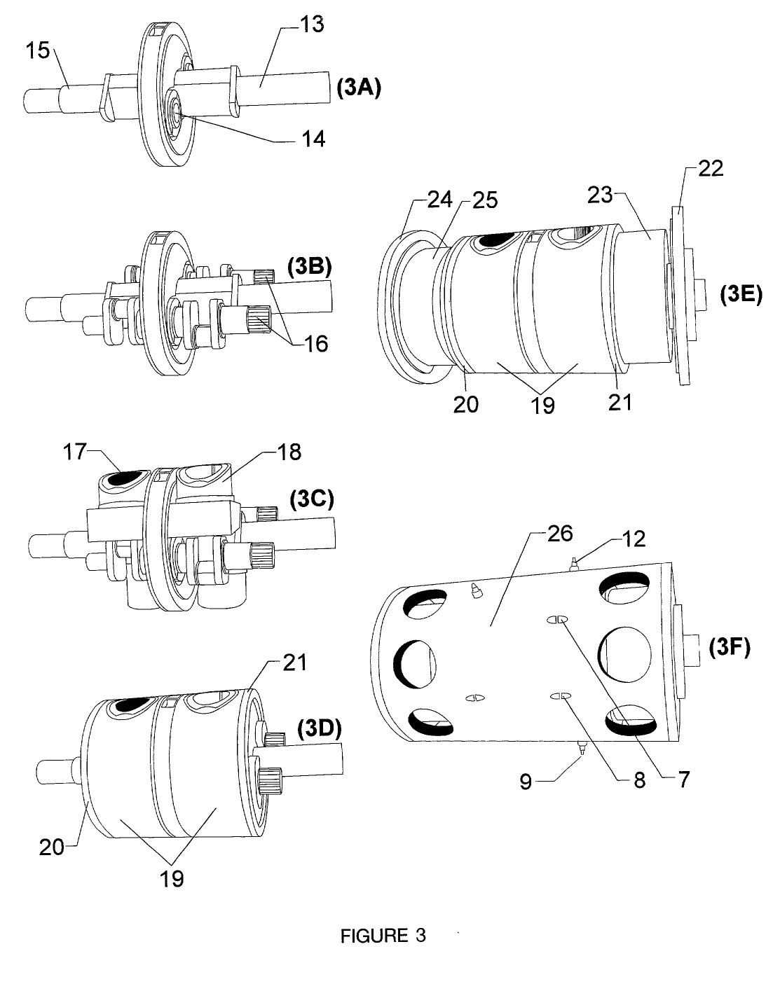

FIG. 4 is perspective view, plan and section view of front end plate of casing and screw gear chamber;

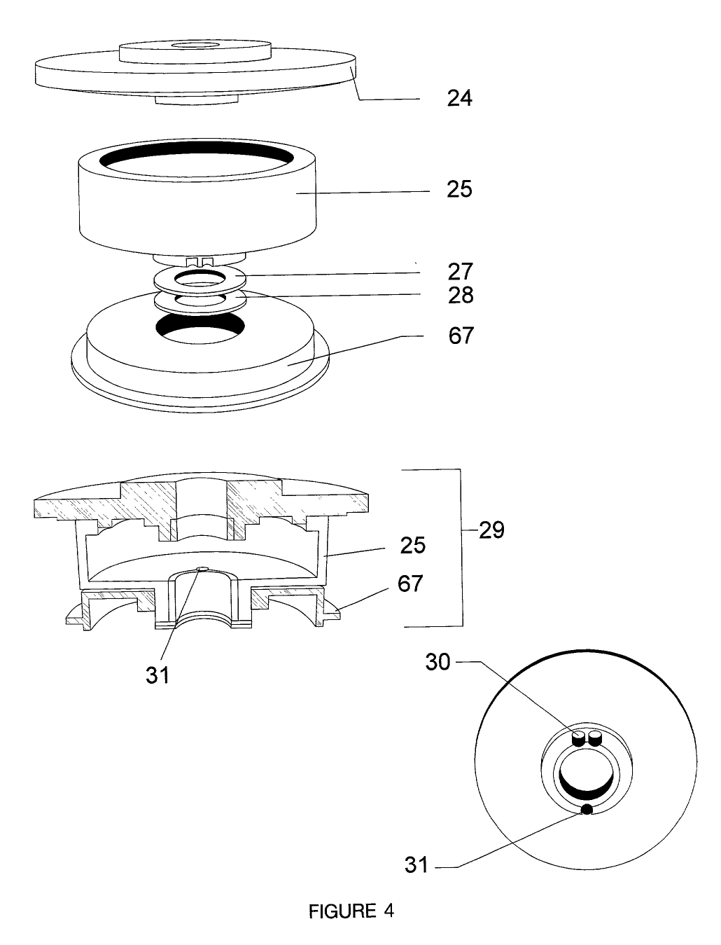

FIG. 5 is perspective and section view of rear end plate of casing and drive train chamber;

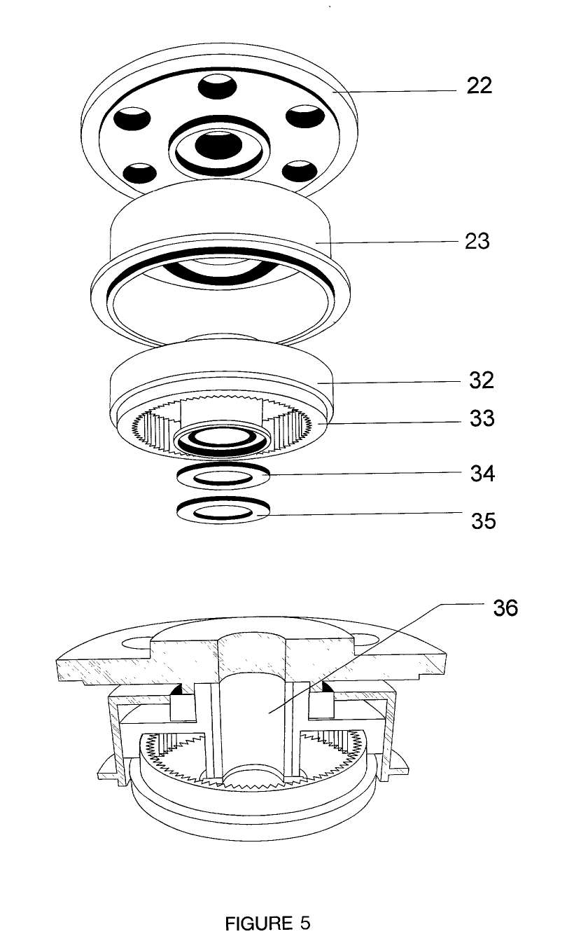

FIG. 6 is perspective and side view of cylindrical shape valve;

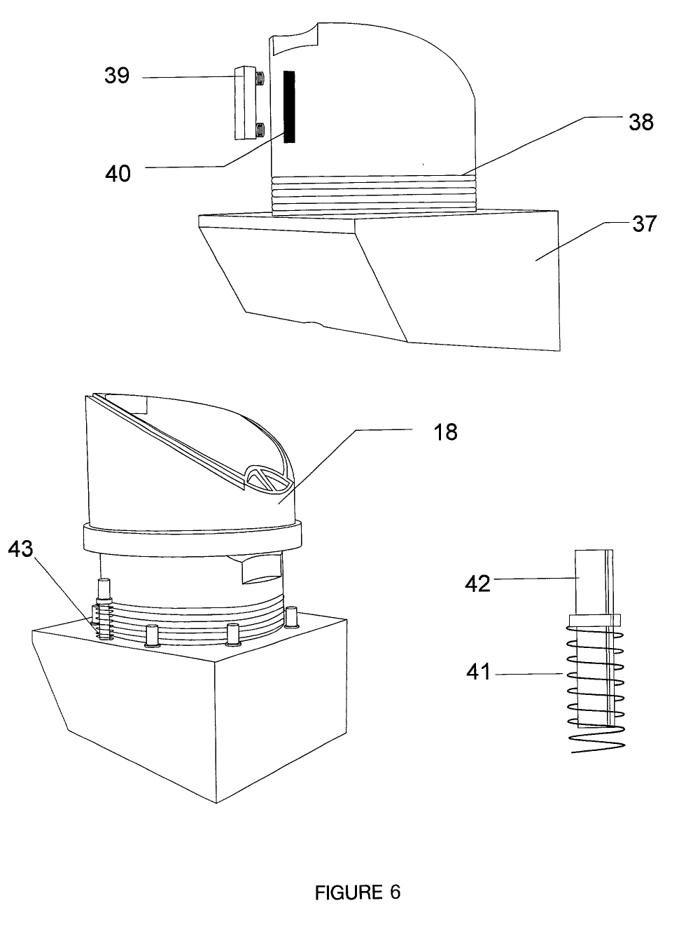

FIG. 7 is perspective and top view of cylindrical shape valve (continue);

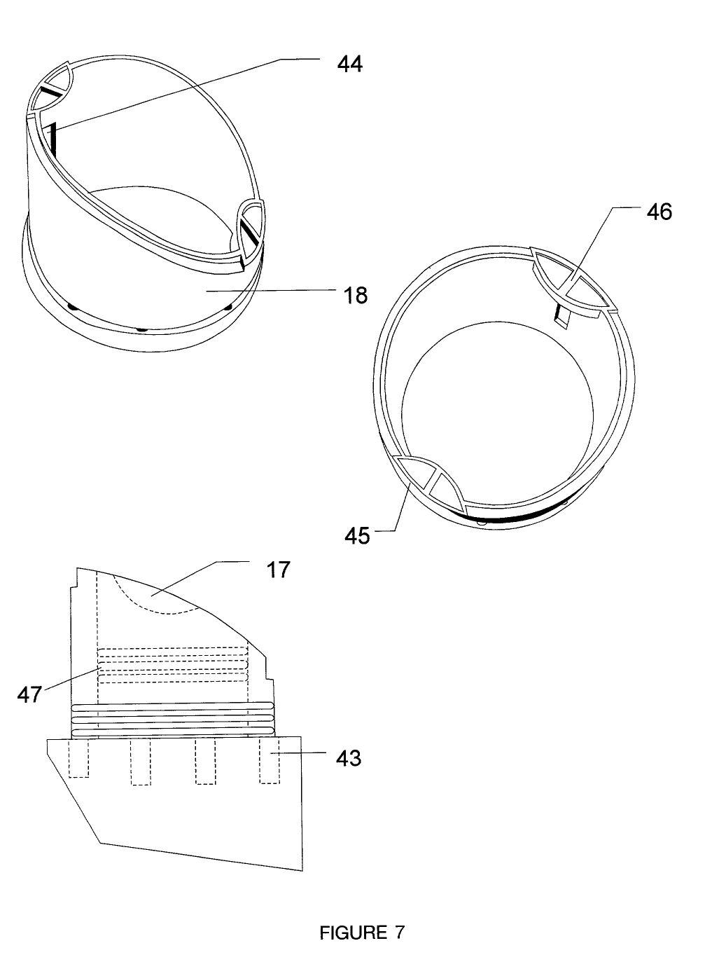

FIG. 8 is perspective rear view of the engine;

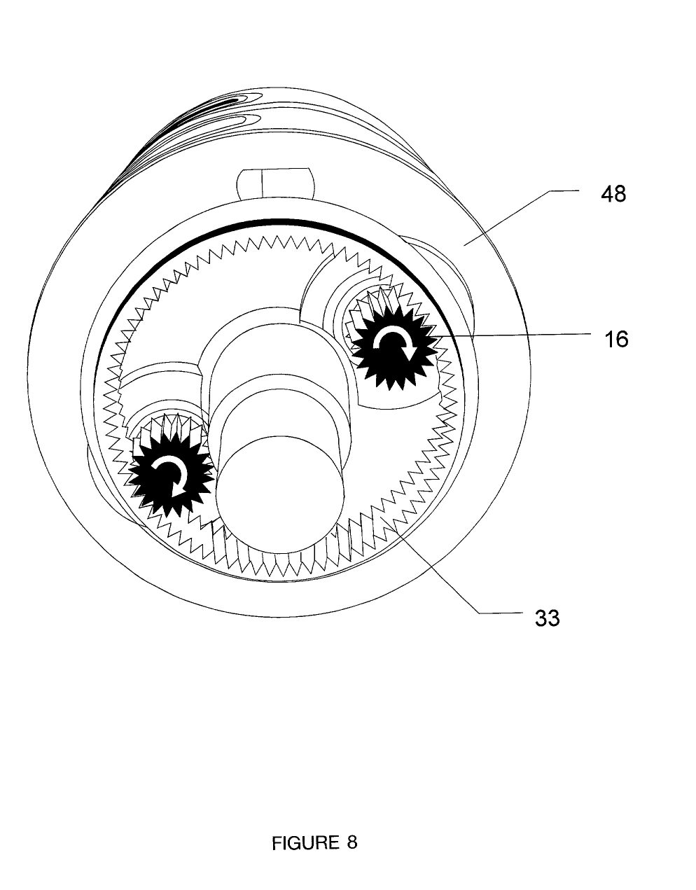

FIG. 9 is perspective front view of the engine;

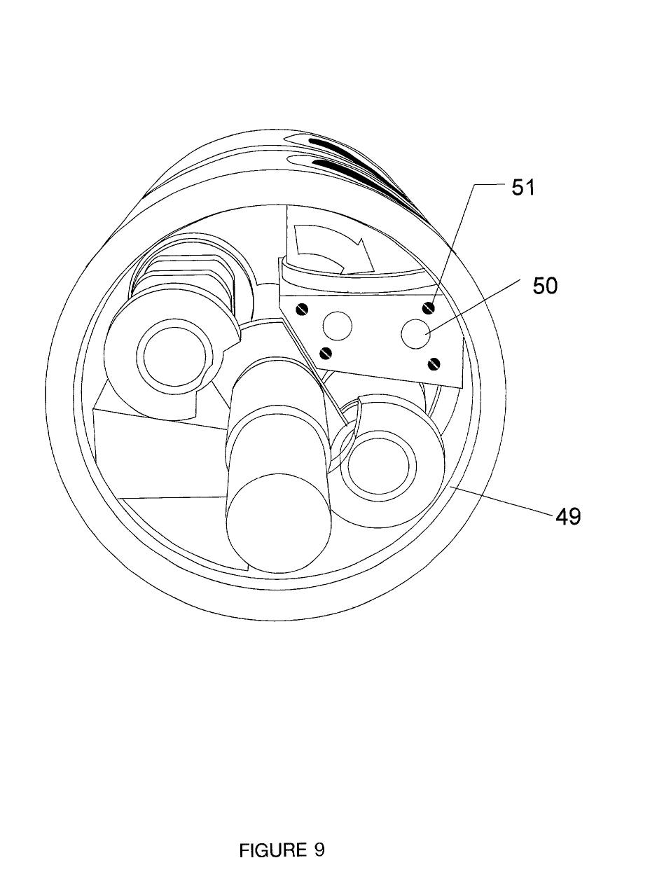

FIG. 10 is perspective view of annular body rotor;

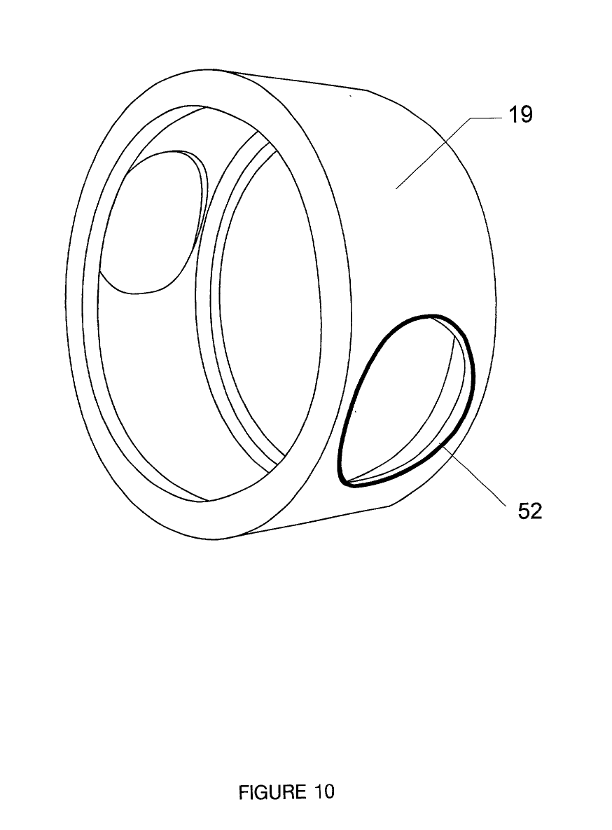

FIG. 11 is perspective view of middle mounting plate of crankshaft;

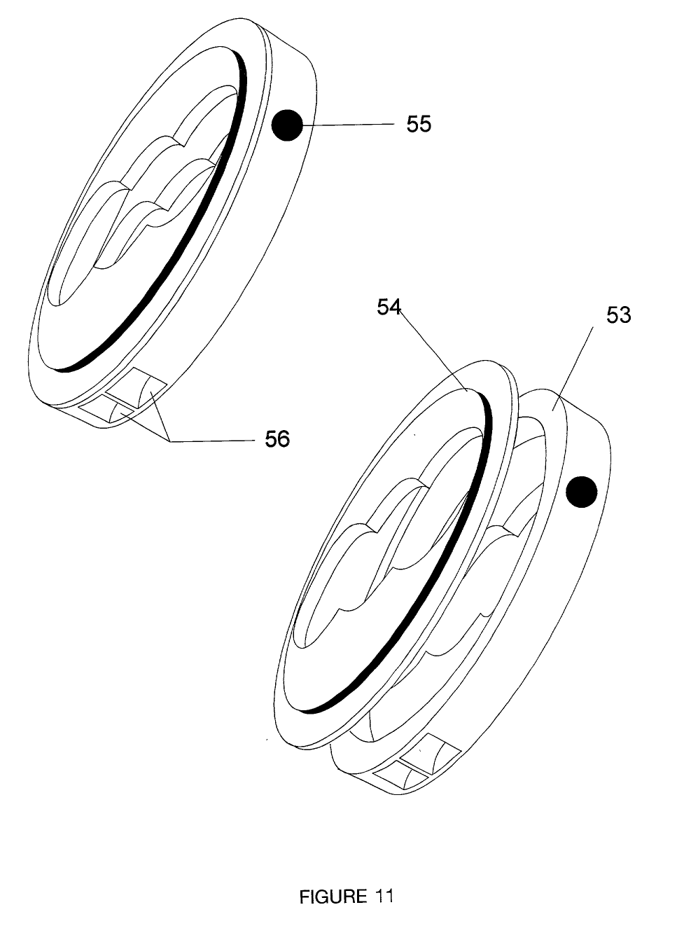

FIG. 12 is perspective view of front mounting plate of crankshaft;

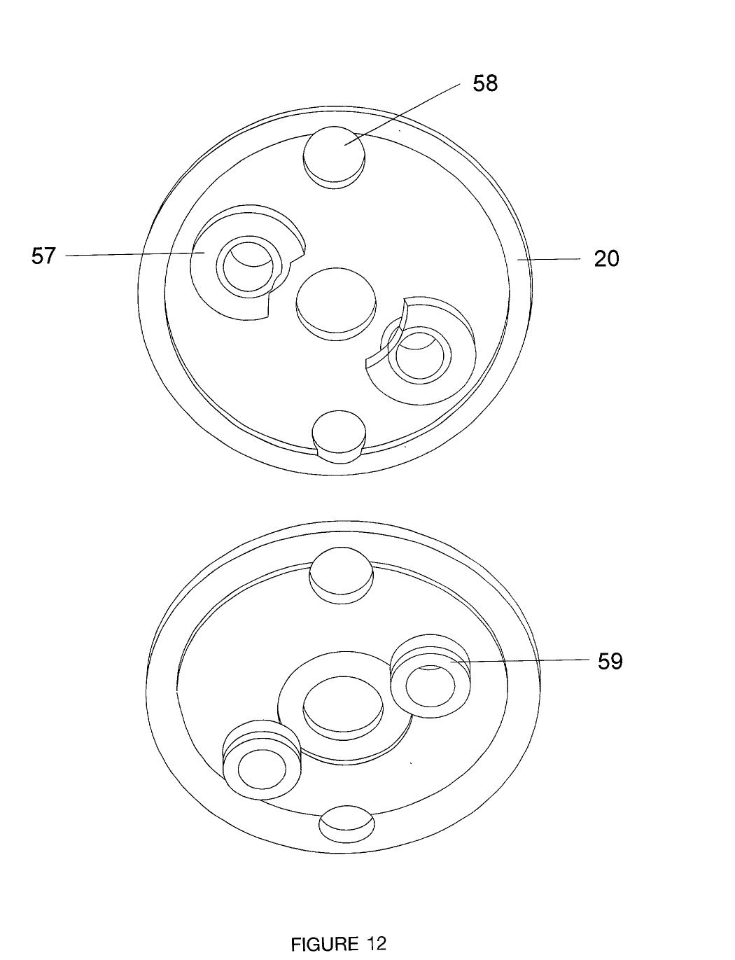

FIG. 13 is perspective view of rear mounting plate of crankshaft;

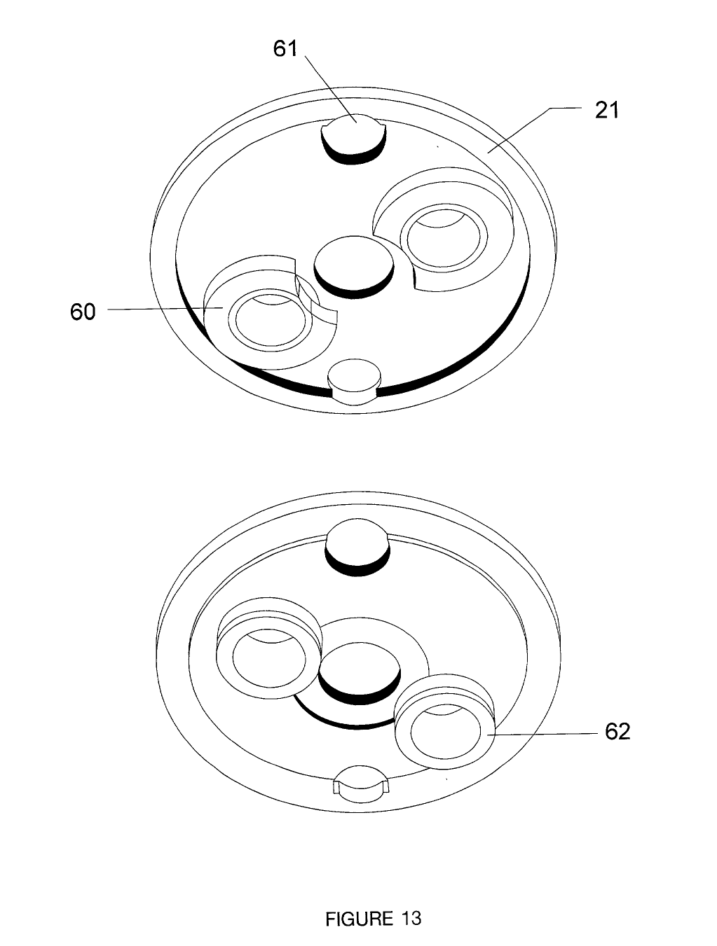

FIG. 14 is perspective view of output shaft and mounting arm of crankshaft;

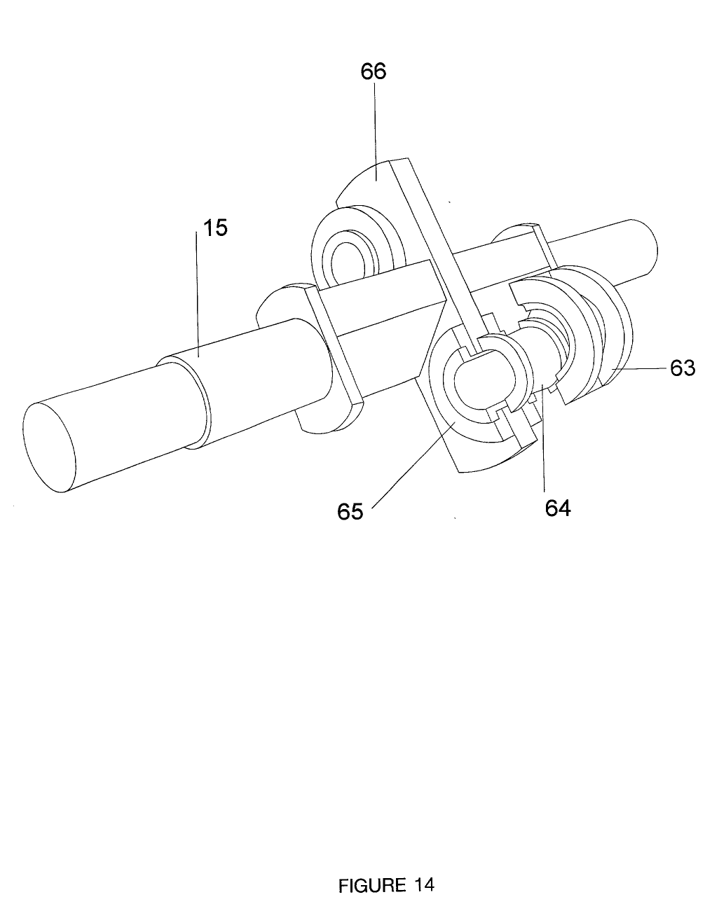

FIG. 15 is two diagrams illustrating suction strokes of the first engine block, and exhaust strokes of the second engine block;

FIG. 16 is two diagrams illustrating compression and explosion stroke of the first engine block, and suction and compression stroke of the second engine block;

FIG. 17 is two diagrams illustrating exhaust stroke of the first engine block, and explosion stroke of the second engine block;

### DETAILED DESCRIPTION OF THE DRAWINGS

The illustrated internal combustion rotary engine comprises a casing formed with a pair of end plates 22, 24 and outer cylinder 26 securely assembled as shown to enclose a cylindrical rotor. The cylindrical rotor has output-shaft 13 as axis. Exhaust-port 7 and suction-port 8 extend through the outer cylinder 26 to provide communication with the cylindrical rotor chamber. Spark plug 9 extends through the outer cylinder 26.

The rotor includes two annular bodies 19 having a cylindrical outer surface matching the cylindrical inner surface formed by outer cylinder 26. The rotor includes front mounting plate of crankshaft 20, and rear-mounting plate of crankshaft 21 secured against the annular bodies 19. The output shaft 13 is rotatably mounted and it extends through the casing by which the sleeve bearing in the end plates 22, 24 of the casing support.

The axis of output shaft and the axis of rotor are the same (concentric) and rotate together.

Between two annular bodies 19 of the rotor is middle mounting plate of crankshaft that comprises mounting plate of output shaft arm 53 and its cover 54. A crankshaft-mounting arm 66 is fixedly secured on the output shaft 13 for bodily rotation with it. A crankshaft-mounting arm 66 includes bearing housing 63, 65 and bearing 64. Piston chambers are fixedly secured with piston chamber bases 37 inside annular body of rotor 19. Each piston chamber axially extends to the outer surface of annular body of rotor 19, and wrapped by its cylindrical shape valve 18. Seal 52 is inserted in annular body of rotor to prevent lube oil leakage from cylindrical shape valve 18. Axis of each piston chamber is perpendicular to the radius of output shaft 13 and preferably uniformly spaced from output shaft axis in the direction of rotor rotation. The cylindrical shape valve 18 is slightly movable along the axis of its piston chamber. The curved end of the valve is pressed with inner cylindrical surface of outer cylinder of casing 26 by coil springs 41 to keep gas tight. The coil springs is seated in spring stem 42 that mounted on piston chamber bases 37 and lower end of cylindrical shape valve 18 to prevent cylindrical valve from moving. At the outer surface of piston chamber base 37 has ring 38 covered to prevent gas leak from cylindrical shape valve 18. Key 39 with spring is mounted in keyway 40, 44 outside of each piston chamber and inside of its cylindrical shape valve 18 respectively. Opening valve 45 is formed at the curve end of cylindrical shape valve 18 to locate the start opening position of exhaust-port and suction-port, and closing valve 46 is located at the start closing position of exhaust-port and suction-port. A piston 17, normally of cylindrical shape similar to conventional construction, is reciprocating in each piston chamber. A piston rod is pivotally connected to each piston 17 and rotatively connected to its corresponding crank of crankshaft 16 by bearing 64. The engine has two engine blocks, the first and the second block, and each block has two pistons. In the first engine block, piston chamber bases 37 are fixedly secured on crankshaft front mounting plate 20 and cover of output shaft arm mounting plate 54. In the second engine block, piston chamber bases 37 are fixedly secured on crankshaft rear mounting plate 21 and output shaft arm mounting plate 53.

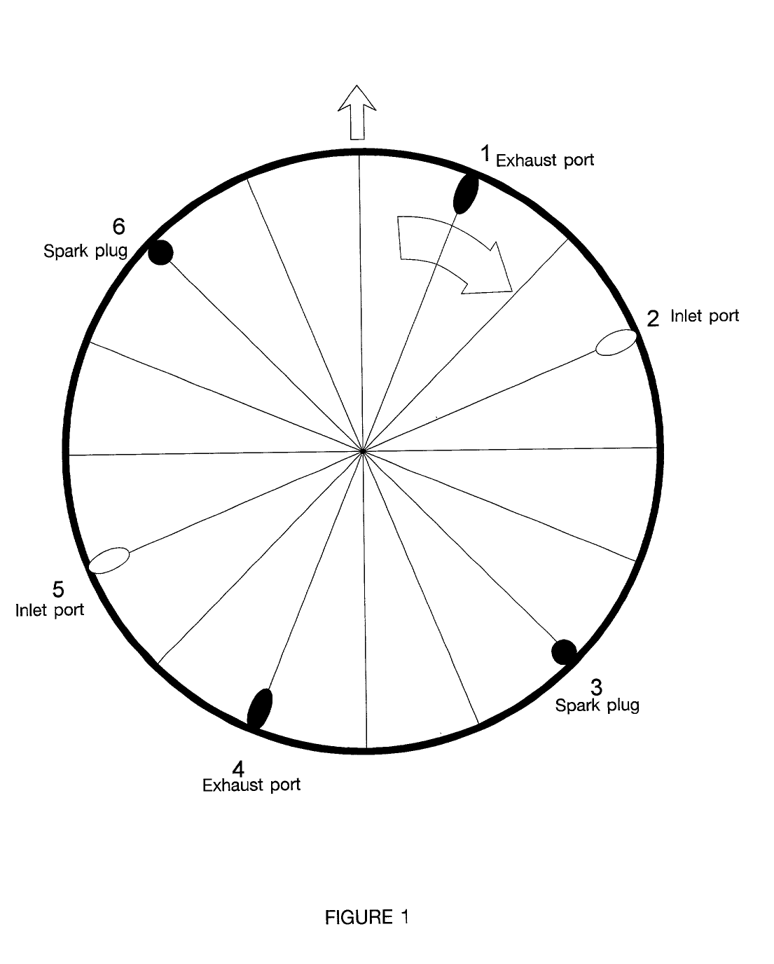

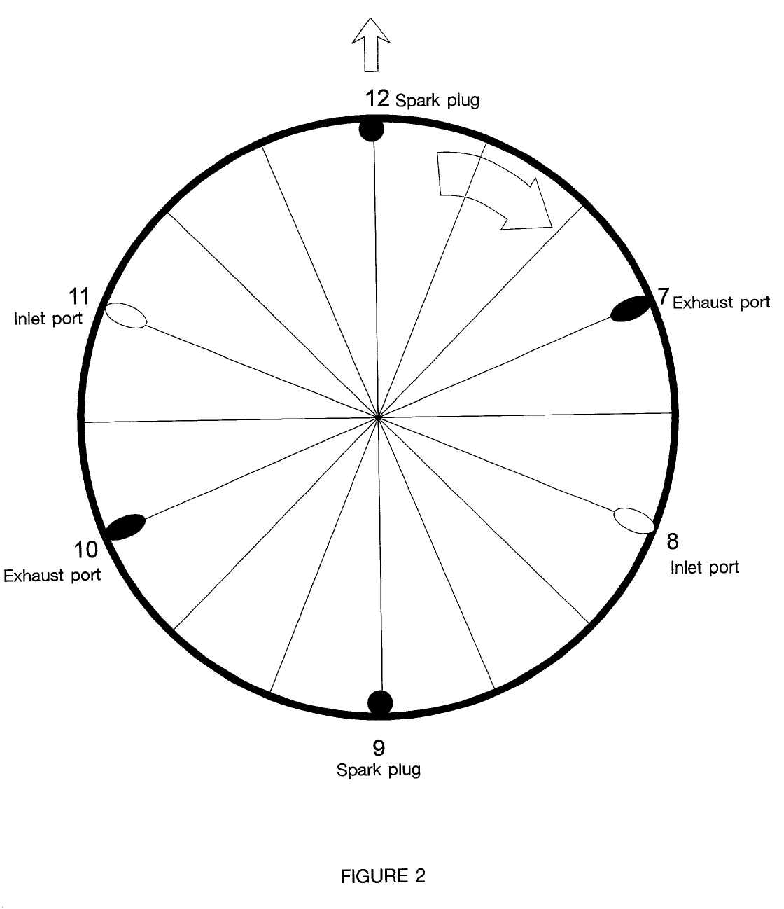

FIGS. 1 and 2, show the position of gas inlet, exhaust outlet and spark plug for the first engine block and the second engine block respectively.

Between front end plate of casing 24 and crankshaft front mounting plate 20 is screw gear chamber 25, which enclose screw gear 15. The screw gear is formed on the front end of output shaft 13 for driving lube oil pump and ignition distributor.

A drive train is provided to synchronize the rotation of the output shaft 13 and both crankshafts 16. The drive train includes an annular gear-carrying cap 32 in drive train chamber 23. The drive train chamber 23 is between rear end plate of casing 22 and rear mounting plate of crankshaft 21. A sleeve to carry the output shaft is formed at the center of annular gear-carrying cap 32 with one end of this sleeve fixedly secured to rear end plate of casing 22. An annular gear 33 is fixed to the annular gear-carrying cap 32. The annular gear 33 mesh with pinion gears formed on the rear end of both crankshafts 16. The drive train shall specify the gear teeth ratio of annular gear to pinion gear to be appropriate to engine efficiency preferably twice the number of pistons in each engine block. For example, in a typical two piston engines the gear teeth ration of annular gear to pinion gear shall be 4:1 so that when the output shaft rotates one round clockwise, the crankshafts will rotate four rounds clockwise. Similarly, the gear teeth ration of 3, 4, 6, 8 piston engine shall be 6:1, 8:1, 12:1 and 16:1 respectively.

As the output shaft 13 and both of crankshafts 16 concurrently rotate, the pistons 17 reciprocate in their piston chamber due to the rotation of crankshaft 16. The reciprocation of the pistons is synchronized with spark plug ignition and the piston chamber then rotate clockwise to the exhaust outlet. To complete combustion cycle, fuel mixture is drawn into piston chamber, compressed, ignited by spark plug, and exhausted while the piston chamber rotate clockwise.

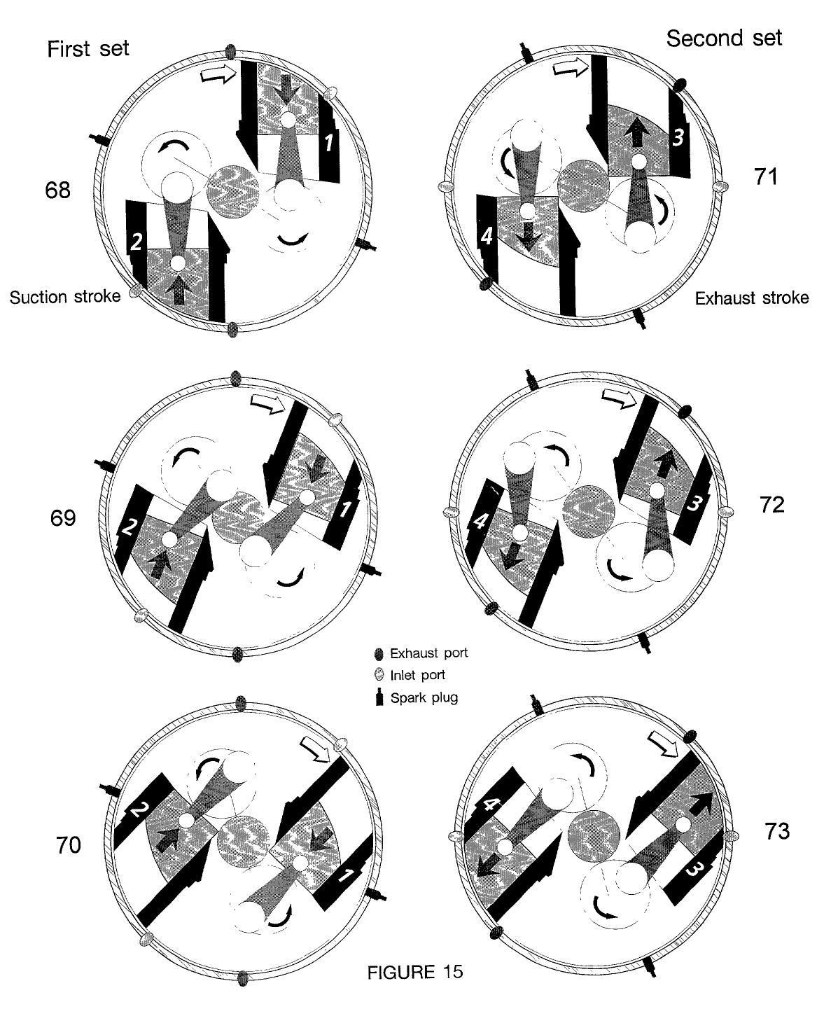

As an example, operation sequence of the engine as shown in the FIG. 15, 16 and 17 illustrates two sets of engine block. Each block comprises two-pistons.

During suction stroke of the first engine block (FIG. 15, No.68, 69, 70), piston chamber No. 1&2 passes through the inlet port while the piston moves down accordingly to suck the fuel air mixture into its piston chamber. When the piston complete its downward stroke, the suction stroke is also complete. At the same time the second engine block is operating in exhaust stroke (FIG. 15, No.71, 72, 73).

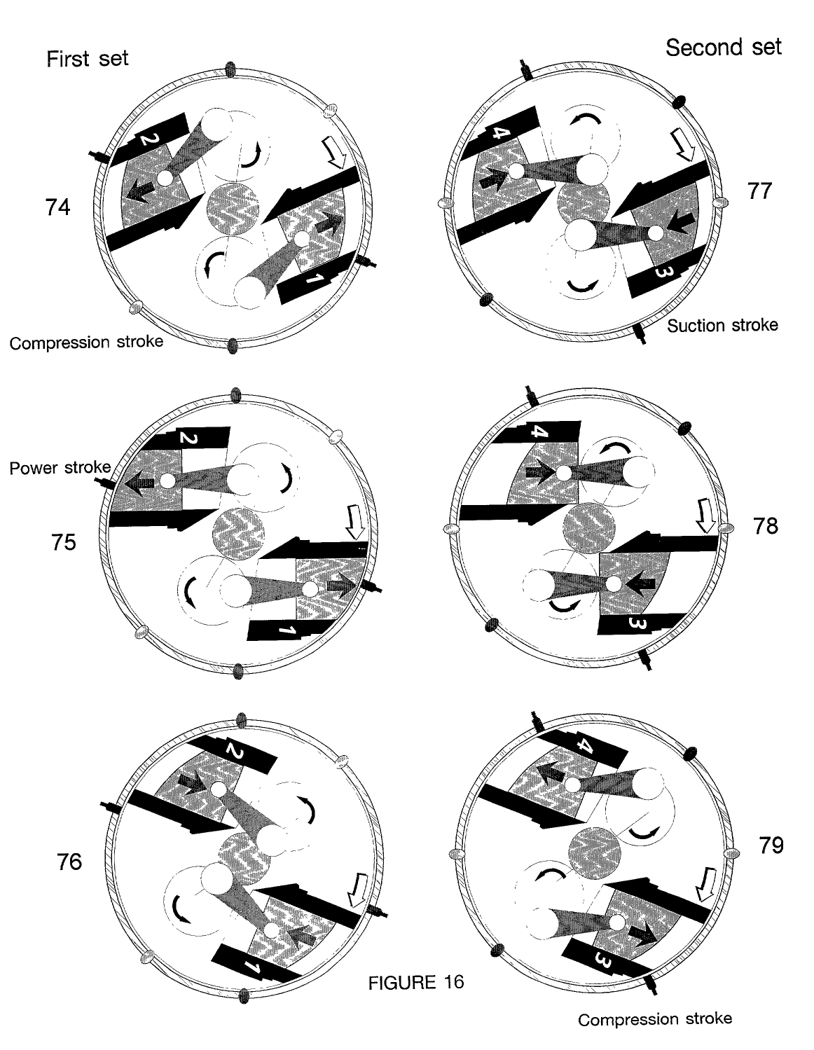

Compression stroke of the first engine block (FIG. 16 No.74, 75) occurs when piston chamber No. 1&2 continues to move around the output shaft while the crankshaft drives piston No.1&2 move up compressing fuel air mixture. At the same time the second engine block is operating in suction stroke (FIG. 16 No.77, 78).

Ignition stroke of the first engine block (FIG. 16 No.75, 76) occurs when piston chamber No.1&2 moves further until the spark plug is positioned at the center of the piston chamber, the spark plug is then ready for ignition. Piston No.1&2 moves down after the combustion of gas in the piston chamber. At the same time the second engine block is operating in compression stroke (FIG. 16 No.79)

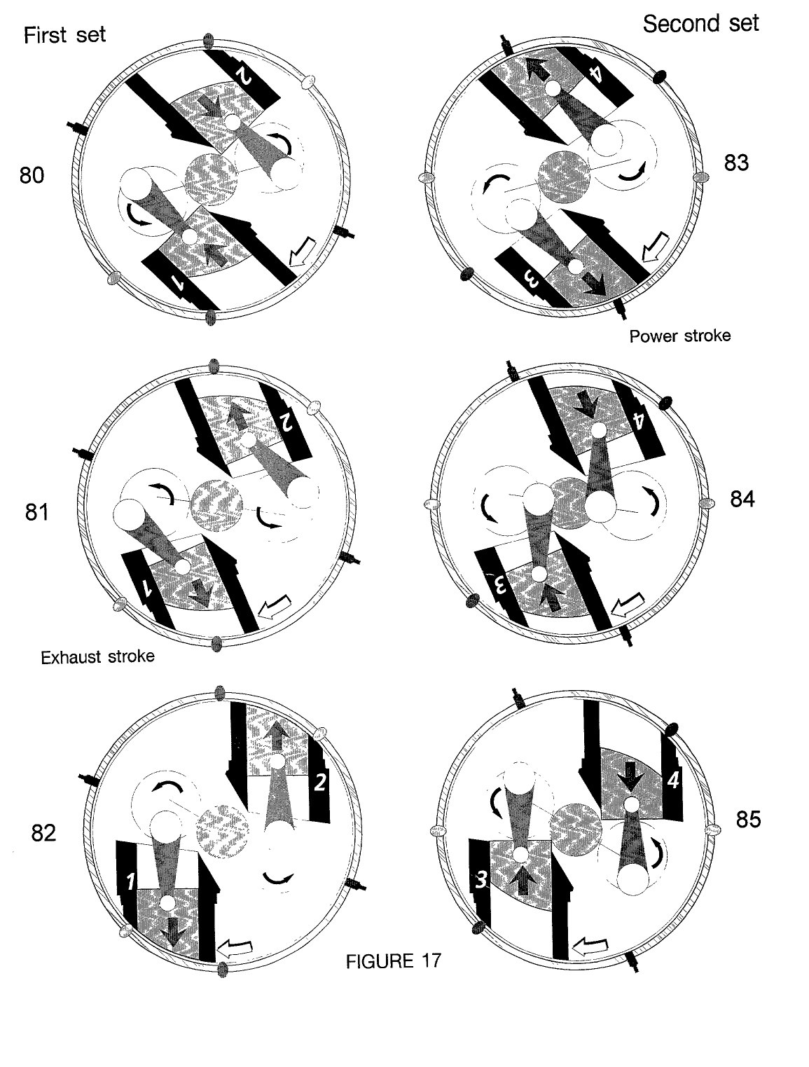

Exhaust stroke of the first engine block (FIG. 17 No.80, 81, 82) occurs when piston chamber No.1&2 complete its downward movement. While moving around to the exhaust port, the piston No.1&2 moves up again to expel the exhaust. When the piston No.1&2 moves up to the top position, piston chamber No.1&2 will pass through and promptly close the exhaust port. At the same time the second engine block is operating in ignition stroke (FIG. 17 No.83, 84, 85).

Piston chamber No.1 and No.2 comprise first engine block while piston chamber No.3 and No.4 form second engine block. The movement of each pair of piston as well as each pair of engine block must be balanced in order to maximize the generation of power. However, this does not limit variation of the invention. Depending on the size and power required, the engine might comprise a plurality of engine block preferably with at least two engine blocks for balancing. Again, one engine block may comprise a plurality of pistons and piston chambers preferably at least two for the same requirement for balancing. Moreover, the ignition stage of each piston will substantially equal to no of piston in each engine block that are three, four, six and eight for 3, 4, 6, 8 piston engines respectively.

Alternative embodiments envision the use of the invention as a compressor or as a pump. A compressor is basically constructed with the same structure as that of internal combustion rotary engine, having cylindrical chamber; rotor with output shaft as its axis in cylindrical chamber; crankshaft, piston, piston chamber within rotor. Expanding piston chamber created by downward movement of piston draws fluid such as air through filter connected with suction port on outer cylinder. After compression, the fluid is driven out of the exhaust port through pipe to a storage tank for future use.

Driven through coupling by electric motor or engine as prime mover, the compressor may be used to compress liquid or gas. While working as a compressor, the reciprocating piston will operate on two-stroke cycle, completing a cycle at each self-revolution of the piston chamber.

What we claim is:

1. An internal combustion rotary engine comprising:
a casing defining a cylindrical chamber with an output shaft rotatably carried through the casing;
rotor means for providing power including annular body, piston chamber means, and output shaft as an axis in the said cylindrical chamber;
piston chamber means within rotor, for receiving therein a reciprocating piston;
connecting means for rotatably connecting the piston, the piston rod and the corresponding crank through crankshaft mounting arm and bearing; crankshaft being uniformly and radially spaced from the axis of the said output shaft, bodily rotatable therewith; and
drive train means to synchronize the rotation of the said output shaft and said crankshafts;
wherein pistons and piston chambers rotate and each piston chamber axis is perpendicular to the radius of output shaft.

2. An internal combustion rotary engine as defined in claim 1, wherein inside the piston chamber is a curved end cylindrical shape valves slightly movable along the axis of said piston chamber, to keep tight contact with inner cylindrical surface of outer cylinder of casing by coil springs to prevent gas leakage; opening and closing valves at the end of cylindrical shape valves to locate the start opening and closing position respectively of exhaust and suction port; outer cylinder with gas inlet port and exhaust outlet port that communicate to piston chambers; outer cylinder with spark plug port to ignite the fuel.

3. An internal combustion rotary engine as defined in claim 1, wherein the drive train means include an annular gear-carrying cap in drive train chamber; At the center of annular gear-carrying cap is formed as a sleeve for bush bearing to carry the output shaft and the rear end of this sleeve is fixed to rear end plate of casing; An annular gear is fixedly mounted to the annular gear-carrying cap; said annular gear mesh with pinion gears formed on the rear end of crankshafts.

4. An internal combustion rotary engine as defined in claim 1, wherein the piston chamber includes the curve end piston to match the inner surface of outer cylinder.

5. An internal combustion rotary engine as defined in claim 1, wherein pistons in the same engine block operate in the same stroke of combustion cycle.

6. An internal combustion rotary engine as defined in claim 1, wherein combustion occurs when piston, piston rod, and crank are perpendicular to the radius of output shaft.

7. An internal combustion rotary engine as defined in claim 1 wherein the engine comprises a plurality of engine blocks.

8. An internal combustion rotary engine as defined in claim 7 wherein each engine block comprises a plurality of pistons and piston chambers.

9. An internal combustion rotary engine as defined in claim 1 wherein the drive train means specify the gear teeth ratio of annular gear to pinion gear to be twice the number of pistons in each engine block.

10. An internal combustion rotary engine as defined in claim 1, wherein combustion cycle for each piston per one round of revolution equal to the number of piston per engine block.

11. A compressor comprising:
a casing defining a cylindrical chamber with an input shaft rotatably carried through the casing;
a rotor for receiving power including annular body, piston chamber and input shaft as the axis in the said cylindrical chamber;
piston chamber within rotor, for receiving therein a reciprocating piston;
connecting means for rotatably connecting the piston, the piston rod and the crankshaft through crankshaft mounting arm and bearing; crankshaft being uniformly and radially spaced from the axis of the said output shaft, bodily rotatable therewith;
a drive train concurrently synchronize the rotation of the said output shaft and the said crankshafts; and
means for reciprocating the pistons within the piston chamber to intake, compress and expel the fluids;
wherein the piston and piston chamber rotate and each piston chamber axis are perpendicular to the radius of input shaft.

12. A compressor as defined in claim 11, wherein inside the piston chamber is a curved end cylindrical shape valves slightly movable along the axis of said piston chamber, to keep tight contact with inner cylindrical surface of outer cylinder of casing by coil springs to protect fluid leakage; opening and closing valves at the end at the end of cylindrical shape valves to locate the start opening and closing position respectively of fluid suction port and exhaust port; outer cylinder with fluid suction port and exhaust port that communicate to piston chambers.

13. A compressor as defined in claim 11, wherein a compressor comprising a plurality of engine block with each of engine block consisting of a plurality of pistons and piston chambers.
